(19) United States
(12) Patent Application Publication
(10) Pub. No.: US 2025/0033481 A1
(43) Pub. Date: Jan. 30, 2025

(54) EXPORTABLE POWER FOR FUEL CELL BUSES

(71) Applicant: BAE Systems Controls Inc., Endicott, NY (US)

(72) Inventors: Gregory P. Marx, Endicott, NY (US); Filippo Muggeo, Endwell, NY (US); Jeffrey Altmire, Apalachin, NY (US)

(73) Assignee: BAE Systems Controls Inc., Endicott, NY (US)

(21) Appl. No.: 18/225,385

(22) Filed: Jul. 24, 2023

(51) Int. Cl. B60L 1/00; B60L 53/20; B60L 53/54; B60L 53/62; B60L 53/66; B60L 58/31

(52) U.S. Cl. CPC B60L 1/006; B60L 53/20; B60L 53/54; B60L 53/62; B60L 53/66; B60L 58/31; B60L 2210/10

(57) ABSTRACT

System and method for generating exportable power from a hydrogen fuel cell. A Modular Propulsion Control System (MPCS) includes a hydrogen fuel cell system interface activated to supply direct current signals from hydrogen fuel cells through a DC-to-DC converter used to power the vehicle; a power bus for receiving the direct current signals from the DC to DC converter; and an electrical port, the electrical port configured to interface with a plug-in charge receptacle connected to a charging station for receiving the directed current signals from the power bus, the dc signals used to provide power to the charging station. A control system employing a vehicle computer and System Control Unit, configures hydrogen fuel cells, a power bus and the plug-in charge receptacle to provide for a specified amount of power to flow out of the vehicle through the MPCS to the ground side charge station.

### FIELD OF THE DISCLOSURE

This disclosure generally relates to systems and methods for vehicle to grid charging, and more particularly, this disclosure relates to a system and method for vehicle to grid charging where hydrogen fuel cells on a hydrogen fuel cell vehicle (HFCV) are configured to generate and add power back into the grid.

### BACKGROUND

Customers are looking for ways to use mass transit vehicles to provide power back to the grid during significant power outage events, such as the aftermath of hurricanes or floods. As more transit agencies transition to zero emission vehicles, which require charging receptacles, there is a desire to utilize that interface not only for bringing power onto the vehicle for charging the high voltage batteries, but also to get power from the vehicle back onto the grid. Specifically for fuel cell vehicles, the on-board hydrogen storage and fuel cell, essentially an on-board generator, would produce the power to be exported from the vehicle out to the grid.

Current vehicle models can be configured with Vehicle-to-grid (V2G) technology that enable power from a vehicle battery to flow back into an electrical network, e.g., the power grid or power distribution grid, or any electrical network that generates and distributes electricity. In current implementations, vehicle car batteries can be charged and discharged based on different signals. In one aspect, signals at the vehicle can be generated to configure vehicle hardware to push charged power from vehicle car batteries back to the power grid in order to balance variations in energy production and consumption.

Current vehicle battery types used in the generation of power for export to the grid include one or more of lithium-ion, lithium polymer, lead-acid, nickel-cadmium, nickel-metal hydride, etc.

To date, there is no known solution for generating electrical power from fuel cells on a hydrogen fuel cell vehicle (HFCV) for the purpose of exporting of power back to the grid.

### SUMMARY

In an HFCV, a system, method and computer program product for generating power from fuel cells and exporting generated power from the vehicle back into an electrical network (i.e., power grid), that generates and distributes electricity.

A bi-directional system including power electronics and controls capable of moving power inbound and outbound from the vehicle.

In one embodiment, the system and method controls the generation of power from a hydrogen fuel cell source before exporting the power from the vehicle back to a ground-side charging station connected to the power grid.

Accordingly, disclosed is a power distribution system in an HFCV. The power distribution system comprises: a hydrogen fuel cell system activated to supply direct current from hydrogen fuel cells used to power the vehicle; a power bus for receiving the direct current from the fuel cell; and an electrical port, the electrical port configured to receive a plug-in connection connected to a charging station external to the vehicle for receiving the directed current from the power bus, the direct current used to provide power to the charging station.

Further, to this embodiment, the power distribution system further comprises: one or more switches connected in series with the power bus, the switch activated to convey the direct current from the power bus to the electrical connector.

Further, in the power distribution system, the plug-in connection connected to the electrical port is a slow charge plug used for providing a charge to a vehicle battery.

According to a further embodiment, the power distribution system further comprises: a processor device coupled to a memory storing program instructions, the program instructions configuring the processor device to: receive a user request signal to export power from the vehicle; and activate the fuel cell system to generate said direct current in response to the user request signal.

In a further aspect, there is provided a method of operating a power distribution system. The method comprises: activating, under command of a processor device, a hydrogen fuel cell system to generate direct current from hydrogen fuel cells used to power the vehicle; configuring, by the processor device, a power bus for receiving the direct current from the fuel cell; and supplying, via an electrical port, the direct current from the power bus to a charging station external to the vehicle, the direct current being supplied to provide power to the charging station.

In one aspect, the power bus comprises one or more switches connected in series, the power distribution method further comprising: activating, by the processor, the one or more switches to convey the direct current from the power bus to the electrical connector.

In a further aspect, the power distribution method further comprises: receiving, at the processor device, a user request signal to export power from the vehicle; and the processor responsively activating the fuel cell system to generate the direct current in response to the user request signal.

In a further aspect, there is provided a computer program product for performing operations. The computer program product includes a storage medium readable by a processing circuit and storing instructions run by the processing circuit for running a method. The method is the same as listed above.

### BRIEF DESCRIPTION OF THE DRAWINGS

FIG. 1 shows a block diagram of an embodiment of a hydrogen fuel-cell vehicle system that is bi-directional, i.e., includes power electronics and controls for moving power both inbound and outbound from the vehicle;

FIG. 2 shows a further detailed diagram depicting the operations for providing power to flow out of the vehicle through the MPCS to a ground side charge station in an embodiment;

FIG. 3 shows a diagram depicting the use of MPCS charge module with additional details of the DC signal bus conductors of the MPCS used to distribute electrical power back to a charging station interfacing with the power grid in accordance with aspects of the disclosure;

FIGS. 4A-4B show a flow chart depicting a method for controlling the flow of power out of the vehicle through the MPCS back to a ground side charge station in accordance with aspects of the disclosure; and

FIG. 5 shows an example housing structure for the components shown in FIG. 1 in an embodiment of the disclosure.

### DETAILED DESCRIPTION

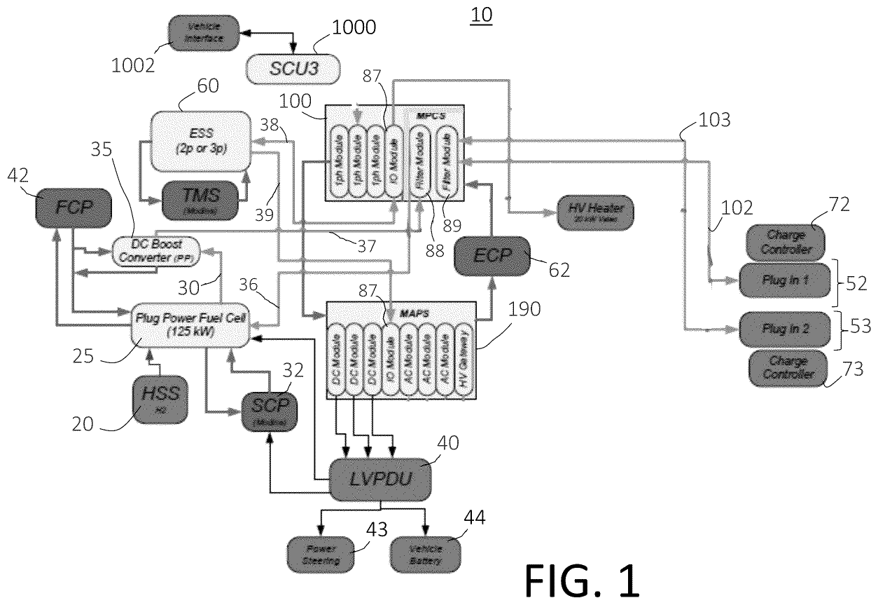

In accordance with aspects of the disclosure, a particular zero emission vehicle (ZEV) is a hydrogen fuel-cell vehicle (HFCV) equipped with system components such as shown in FIG. 1. In particular, FIG. 1 shows a block diagram of an HFCV system 10 that is bi-directional, i.e., includes power electronics and controls for moving power both inbound and outbound from the vehicle. While descriptions herein relate to an HFCV, the system of FIG. 1 may be used in hybrid electric vehicle (HEV) or a battery electric vehicle (BEV). The vehicle may be a personal vehicle, such as a scooter, car, motorcycle and truck or a commercial vehicle such as a truck or bus, a vehicle such as a boat or submarine or a military vehicle such as a tank, self-propelled artillery, or troop transport. The vehicle may also be an airplane, helicopter, UAV, and other powered air vehicles.

In such an HFCV system, the vehicle is not powered by a battery per se but a fuel cell stack of Hydrogen gas. The stack of Hydrogen gas fuel cells 25 include pure hydrogen (i.e., H₂) fuel cells that, as known, pass H₂ gas through a membrane (not shown) to combine with oxygen (O₂) from the air to produce electricity with water and heat as by-products. In particular, the hydrogen fuel cell system is activated to supply direct current from hydrogen fuel cells used to power the vehicle. The direct current produced is conveyed within a power distribution system on a fuel cell vehicle to power the motor to turn the wheels of the vehicle. Hydrogen gas is supplied via a hydrogen storage system (HSS) 20, i.e., fuel is brought in from tanks externally, and the fuel is used to make electricity. In an embodiment, from 40 kg-60 kg of Hydrogen is provided on board the vehicle for DC power generation.

Moreover, unlike a battery electric bus, that has a limited amount of energy on the vehicle, the fuel cell bus has the capability to be an on-board generator for an unlimited amount of time with the proper amount of fueling. The fuel cell generates direct current electricity and this electricity is conveyed over a conductor 30 to get boosted by a DC-to-DC Boost Converter element 35 which is a step-up converter to step up the voltage generated by the fuel cells 25 for output to a load. In an embodiment, DC-to-DC Boost Converter element 35 can boost DC voltage produced at the fuel cell stack, e.g., from 340 VDC to 650 Volts DC. As shown in FIG. 1, the boosted DC current (e.g., 650 Volts DC) is conveyed over a further high voltage DC conductor 37 for input to a Modular Propulsion Control System (MPCS) 100 that distributes the power to various sub-system components, e.g., power converters for charging high-voltage batteries in vehicles such as hybrid electric vehicles, such as described in commonly-owned, co-pending U.S. patent application Ser. No. 18/067,208 [attorney docket no. 22-BAE-0222; 41532].

In one embodiment, the MPCS 100 provides, over a bi-directional high voltage DC conveyance bus 38, power to the high-voltage Energy Storage System (ESS) 60 which is a device or group of devices assembled to store energy in order to supply electrical energy over a further high voltage DC bus 39, to power various vehicle system components and accessory systems (e.g., air conditioning, heaters) at any time. In an embodiment, the high voltage ESS may be a battery. Energy stored at the ESS can be used to power the traction motor during acceleration of the vehicle and receives regenerated power or power recovered as a result of deceleration for storage thereof when the vehicle decelerates. A further DC voltage bus 36 from the MPCS 100 is used to convey further power for powering the components of the fuel cell stack 25 such as the heaters and blowers to render a net power fuel cell stack output of about 125 kW.

As further shown in FIG. 1, a fuel cell Stack Cooling Package (SCP) 32 includes a thermal controller and heat-exchange components (not shown) to provide passive cooling to the fuel cell stack 25 in order to meet fuel cell conductivity requirements and predictively manage the temperature of the fuel cell stack while minimizing power draw. Power to operate the SCP 32 and fuel cell stack 25 is provided over low voltage buses provided by a low voltage power distribution unit (LVPDU) 40 additionally shown interfacing with vehicle power steering components 43 and the vehicle battery 44. A further electronics cooling package 42 is provided for cooling down various components on the vehicle such as the DC-to-DC power boost converter 35 and the power fuel cell power electronics components 25 on the vehicle. Electronics cooling package 62 provides a further solution for cooling down various power electronics at the MPCS 100 and a Modular Accessory Power System (MAPS) module 190 on the vehicle. As shown in FIG. 1, the ESS interfaces to the MPCS and MAPS by respective outbound DC links (voltage buses) 38, 39 to the MPCS 100 and MAPS, respectively.

In embodiments herein, the HFCV includes a system control unit (SCU) 1000 in the form of at least one control processor, memory and a communication interface 1002 for interfacing with and controlling vehicle system components or equipment. The communication interface may be control automation network CAN. The processor may be an FPGA. In other aspects, the processor may be a microcontroller or microprocessor or any other processing hardware such as a CPU or GPU. Memory may be separate from the processor (as or integrated in the same). For example, the microcontroller or microprocessor includes at least one data storage device, such as, but not limited to, RAM, ROM and persistent storage. In an aspect, the processor may be configured to execute one or more programs stored in a computer readable storage device. The computer readable storage device can be RAM, persistent storage or removable storage. A storage device is any piece of hardware that is capable of storing information, such as, for example without limitation, data, programs, instructions, program code, and/or other suitable information, either on a temporary basis and/or a permanent basis. The communication interface may also be other network interfaces such as an ETHERNET, serial such as ARINC 429, 422, 485 interfaces or a wireless interface.

As described in embodiments herein, the SCU 1000 communicates with a vehicle control module and the MPCS 100 via communication interfaces such as a Controller Area Network (CAN) and is configured for additionally controlling power flow out of the vehicle through the MPCS to a ground side charge station.

In one embodiment, under control of the SCU 1000, one filter module 88 of the MPCS 100 receives the power from the fuel cell and distributes it out to the high voltage DC Link or auxiliary input of the fuel cell. A further filter module 89 of the MPCS is used to provide power back to the power grid in the manner described herein. Another module of both the MPCS 100 and MAPS 190 is an I/O module 87 configured to receive energy from the ESS 60 over respective voltage bus 38, 39.

In accordance with aspects of the disclosure, FIG. 1 depicts a HFCV-based system for generating exportable power from a hydrogen fuel cell engine and moving generated power outbound from the vehicle to the power grid through the MPCS 100.

In view of FIG. 1, while the MPCS 100 has been used to manage power flow into the vehicle for the purpose of charging high voltage batteries in electric buses, in an aspect of the present invention, the MPCS is configurable to control and also allow for power to flow out of the vehicle through the MPCS to a ground side charge station. Particularly, the MPCS provides the exportable power by first moving power from the fuel cell(s) 25 to the MPCS 100, and from the MPCS 100 over one or more high voltage (HV) direct current bus conductors, e.g., DC conductors 102, 103, through corresponding one or more plug-in ground-side charger receptacles 52, 53 (i.e., vehicle electrical ports 52, 53 providing plug-in connections) back to the power grid. Through each respective plug-in receptacle 52, 53, installed on the vehicle is a further connection to a ground side charging station that converts direct current energy provided by the vehicle into alternating current (AC) power for input back to the power grid. Connecting to each respective plug-in receptacle 52, 53 is a respective charge controller 72, 73 that controls operations for charging high voltage Energy Storage Systems. Through each plug-in receptacle, the ground side charging station communicates with the charge controller when plugged-in to a vehicle according to a Power Line Communication (PLC) Protocol, as defined in the SAE J1772 standard. The charge controller communicates with the SCU 1000 over a Control Area Network (CAN) in accordance with the SAE J1939 vehicle standard for communication, in order to communicate power charging information for the vehicle to use when being charged. In embodiments of the invention, each charge controller interprets information from the ground side charging station over a power line communications bus conductor (not shown) and communicates with the SCU 1000 in order to provide useful information back to the vehicle about the power being exported back to the grid, as conveyed by messaging in accordance with the SAE J1939 vehicle standard for communication. According to an embodiment, the charge controller will provide information about the current and voltage the vehicle can supply to the ground-side charging station for exportation back into the grid.

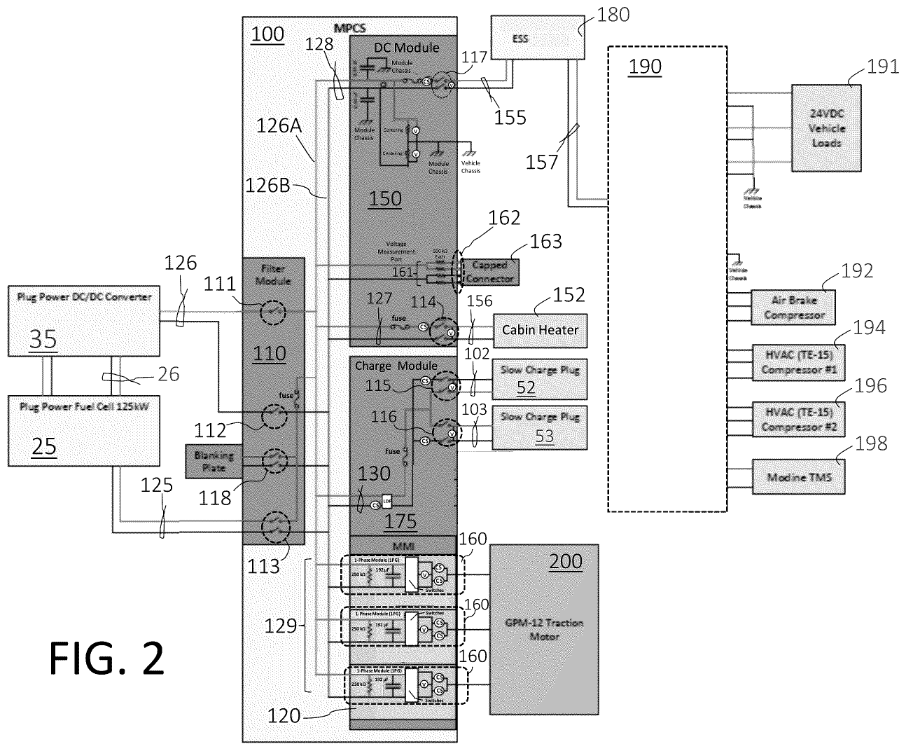

FIG. 2 shows a further detailed diagram depicting the operations for providing power to flow out of the vehicle through the MPCS to a ground side charge station in an embodiment. As shown in FIG. 2, the fuel cell 25 is a fuel cell stack and in embodiment, has a rated net power of at least up to 125 kW providing voltages ranging from between 500 to 750 V. The fuel cell 25 converts Hydrogen fuel (i.e., Hydrogen per International Standard ISO 14687-2:2012) to electric energy using processes as known in the art. The power system for generation of electricity on a fuel cell vehicle can include, but is not limited to, other components such as: fuel cell stack, air processing, fuel processing, thermal and water management (not shown).

Referring to FIG. 2, fuel cell 25 interfaces and provides output dc voltage signals 26 to the DC/DC converter 35 that interlinks the output of the fuel cell stack with the DC link voltage of the traction inverter and a high-voltage traction battery (not shown). In an embodiment, the fuel-cell DC/DC converter 35 is a DC boost converter that steps-up the output voltage signals of the hydrogen fuel cell stack 25. In embodiments, a filter module 110 of the MPCS 100 directly receives the boosted DC voltage signals via conductors 126 from the DC/DC converter 35 and passes through the boosted DC voltage signals back to the hydrogen fuel cell 25 via conductors 125 for powering fuel cell accessories, such as heaters and pumps. In an embodiment, boosted DC signals 126 are received at filter module 110 and conducted to DC buses 126A, 126B within the MPCS module 100 via respective switches or relays 111, 112. Signals 125 are routed back to the fuel cell 25 via respective switches or relays 113. In an embodiment, DC bus 126A is configured for carrying +'ive (positive) high DC voltage while DC bus 126B is configured for carrying a −'ive (negative) high DC voltage.

In one embodiment, as shown in FIG. 2, the MPCS 100 conveys generated electric DC signals (power) in both directions along DC voltage bus lines 126A, 126B of the MPCS to various sub-components including a filter module 110, DC module 150 and charge module 175. In one embodiment, a DC bus portion 127 conveys the generated electric DC signals from bus 126A, 126B to a cabin heater module 152 used to heat the vehicle. In particular, switches 114 are connected in series with each +'ive and −'ive signal carrying bus line 127 that can be activated (i.e., closed) to enable power flow to the power heater module, e.g., over a further DC bus portion 156. Further, MPCS 100 includes DC bus portion 128 that conveys generated electric DC signals from bus 126A, 126B to a power supply or energy storage system (ESS) 180 used to supply power to other components internal and external to the vehicle. In particular, switches 117 are connected in series with each +'ive and −'ive signal carrying bus line 128 that can be activated to enable power flow to/from the (ESS) positive and negative terminals, e.g., over a further DC bus portion 155. In an embodiment, ESS 180 includes fuses, contactors, a controller card and battery cells to generates power along bus 157 that is used to power a Modular Accessory Power System (MAPS) module 190 of the HFCV. The MAPS module 190 supplies power to operate AC and DC accessory drives for electric components including, but not limited to: an electric alternator, electric steering, electric air brake compressors 192, HVAC compressors 194, 196, and thermal management system (TMS) 198, and to other 24 V DC vehicle loads 191 including, but not limited to: water pumps, fans, lighting, and low voltage batteries.

As shown in FIG. 2, the MPCS module 100 further includes an external voltage measurement connector that includes a port 162 having redundant connections to each of the +'ive DC bus line 126A and −'ive DC bus line 126B through in-series connected resistors 161. In one embodiment, the voltage measurement connector port 162 is accessible by a user to enable the user to take a high voltage measurement at each bus line and verify whether system power is turned on or off prior to the user decommissioning a vehicle or replacing any line replaceable units (LRUs). As shown in FIG. 2, the connector port 162 is capped with a blanking plate or mating connector 163.

In one embodiment, as shown in FIG. 2, the MPCS 100 includes DC voltage bus portions 129 that convey generated electric DC signals from bus 126A, 126B of the MPCS to a machine, e.g., a traction motor assembly 200 of a HFCV. The power supplied can be used to operate the traction motor at one or more phases. For example, the generated electric DC power from bus 126A, 126B is conducted to a three phase inverter module 120 for supplying DC voltage used to operate one or more parallel operated gate driver circuits 160 for driving one or more phase loads.

That is, in one embodiment, the MPCS 100 is a modular line replacement unit (LRU) containing a plurality of inverters modules in addition to high voltage power distribution. The MPCS is scalable and customizable to have any number of inverter modules and distribution interfaces. Different inverter modules may support and/or provide different phases of power. Each inverter module may have a wide bandgap switching unit having 3 or more phases of switching pairs.

In one embodiment, as shown in FIG. 2, the MPCS 100 includes DC voltage bus portion 130 that conveys generated electric DC signals to/from bus 126A, 126B of the MPCS to at least one slow charge plug used for supplying power to and receiving power from the power grid according to embodiments herein. In embodiments, respective plug-in receptacles 52, 53 are slow charge plug-ins configured for slow charging the electric or hybrid vehicle, e.g., at slow charging rate, e.g., between 2.3 kW and 3 kW. In particular, DC bus 130 is split into two signal paths that each convey power to a respective plug-in charge receptacle 52, 53 via respective electrical conductors 102, 103. MPCS 100 is shown conveying generated electric DC signals along bus 126A, 126B of the MPCS to the charge module 175 that can be configured to transfer power out of the MPCS and through the plug-in charge receptacle for input back into the power grid. In one embodiment, in-series switches 115 at one path are operable to conduct generated DC signal over conductors 102 for input as DC power back into the power charging station or grid via first plug-in charge receptacle 52. Similarly, at the other path, in-series switches 116 are operable to conduct generated DC signal over conductors 103 for input as DC power back into the power charging station or grid via second plug-in charge receptacle 53. Operationally, only one plug-in charge receptacle is used at any given time.

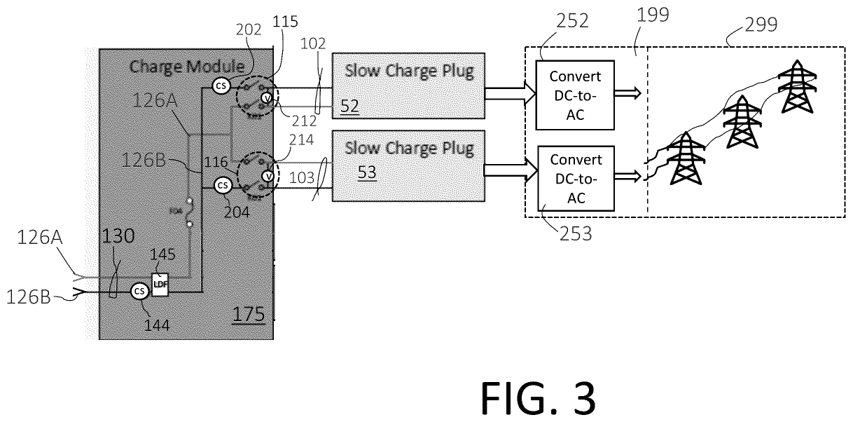

FIG. 3 shows a diagram depicting the use of MPCS charge module 175 with additional details of the DC signal bus conductors 126A, 126B of the MPCS used to distribute electrical power back to a charging station 199 interfacing with the power grid 299. In one implementation, DC voltage bus portion 130 is split to form two DC bus paths 102, 103, each respective DC bus path 102, 103 directly carrying the power created at the hydrogen fuel cells (e.g., 125 kW or about 200 Amps at 650 V) back to the grid through respective plug-in charge receptacles 52, 53 at a ground side charge station, e.g., electric vehicle supply equipment (EVSE) (not shown). Alternatively, along these paths, DC power can be provided from the grid 299, through the ground side charging station 199 to a plug-in charge receptacle 52, 53 back to the vehicle MPCS as a DC voltage, e.g., for the purpose of charging high voltage energy storage systems or climate control preconditioning, e.g., warming or cooling the vehicle cabin, in an HFCV.

In embodiment, each plug-in charge receptacle 52, 53 interfaces with a respective ground side charging station 199 that is an external component used to convert any DC signals generated by the fuel cells into usable AC signals suitable for input to the power grid. At each DC bus path 102, 103, the charge module 175 includes a corresponding pair of switches 115, 116 controlled by respective control signals generated by the SCU 1000 to control current flow from fuel cells to the grid through respective plug-in charge receptacle devices 52, 53 and DC-to-AC type converters 252, 253 of ground side charging station 199. In an embodiment, any power flow from the fuel cells to each respective plug-in charge receptacle 52, 53 through buses 102, 103 are respectively measured by current meter and voltage meter so as to ensure power conveyance amounts. For example, along DC bus path 102, there is configured in-line electric current sensor meter 202 and voltage meter 212 both used for monitoring an amount of generated power (electric DC signals from fuel cells) transferred back to the power grid via the first slow charge port 52 through closed switches 115. Similarly, along DC bus path 103, there is configured in-line current sensor meter 204 and voltage meter 214 both used for monitoring an amount of generated power (electric DC signals from fuel cells) transferred back to the power grid via the slow charge port 53 through closed switches 116. The signal measurements at current sensors 202 and voltage sensor 212 are used by the SCU 1000 to regulate and monitor the flow of power back to the power grid via plug-in charge receptacle 52, while the signal measurements of current sensors 204 and voltage sensor 214 are used to regulate and monitor the flow of power back to the power grid via plug-in charge receptacle 53. It is understood that while there are two slow charge plugs shown connecting to the DC voltage bus, in an implementation, one can be accessible in the front of the unit or back of the unit or alternatively, the right side of the unit or alternatively, the left side of the unit.

In operation, only one plug-in charge receptacle 52 (or 53) is usable when exporting power back to the grid. Each plug-in charge receptacle 52, 53 complies with the Society of Automotive Engineers (SAE) J1772 standard that defines the common charging method for electric vehicles (EVs) and plug-in hybrid electric vehicles (PHEVs). The SAE J1772 standard defines how the ground side charge station connects with, communicates with, and charges the vehicle high voltage energy storage system. The ground side charging station performs a “handshake” with the SCU and charge controller to ensure safe charging. The SCU and MPCS provide for the on-board distribution of the DC output from the charging station and adjusts it to the battery level. In an embodiment, at the vehicle, the SCU transmits a handshake message via the power bus to the ground side charging station. The power bus includes a charge controller interfacing with the ground side charging station. The handshake message includes data representing the configuration of the plug-in charger 52, 53.

As further shown in FIG. 3, the DC bus 126A, 126B of the MPCS is further provided with a low droop filter 145 that filters the power signals from bus 126A, 126B to provide very low-dropout voltage, low noise, and low quiescent currents, suitable for lower voltage applications.

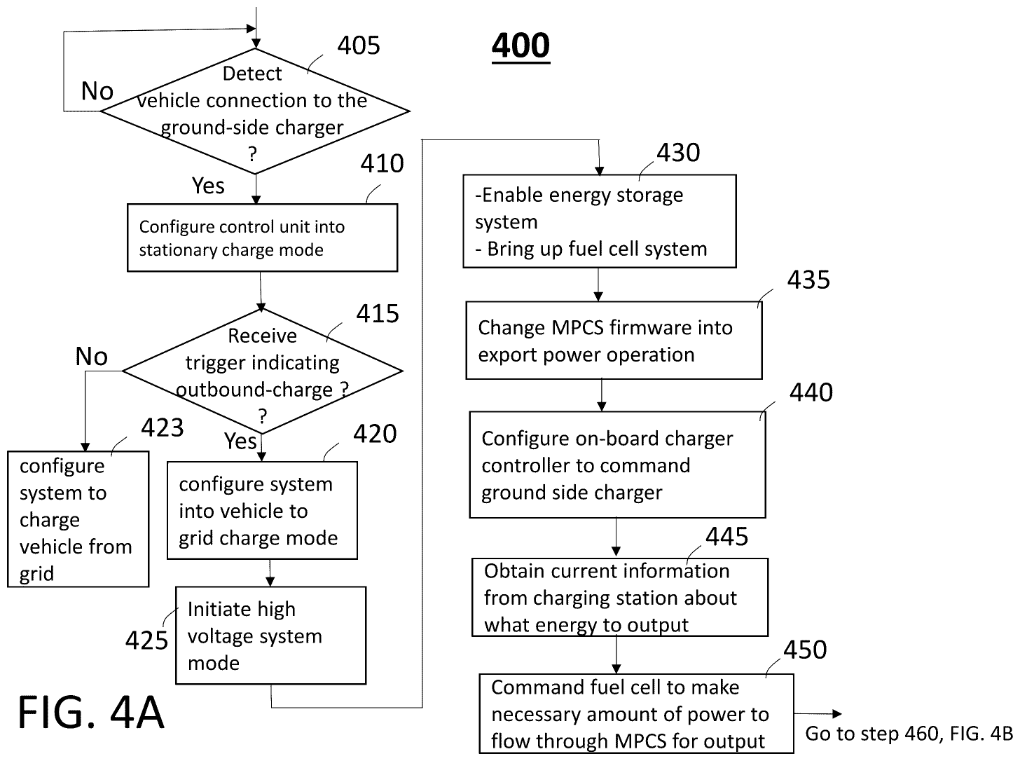

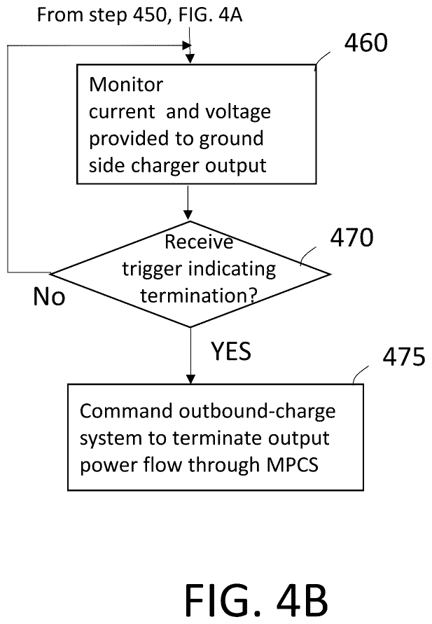

FIGS. 4A-4B show a flow chart depicting a method 400 for controlling the flow of power out of the vehicle through the MPCS back to a ground side charge station. In an embodiment, the SCU 1000 is programmed with controller software used to control the flow of power out of the vehicle and back to the power grid via the charge station.

In accordance with a first step 405, the SCU control scheme provides a listening mode to detect any connection of the vehicle to the ground-side charger associated with the power grid. That is, when the vehicle is plugged-in to the ground side charger, it wakes up the SCU and commands it into a stationary charge mode. For example, a respective charge controller 72, 73 at a corresponding respective plug-in module 52, 53 can communicate with the SCU 1000 to provide control of operations for exporting power from the fuel cells on the vehicle to the power grid using current and voltage requested by the ground side charging station. Until the SCU detects a plugged-in connection, the SCU control processor remains in control over other processes. Then, at 410, once the SCU controller detects any connection of the vehicle to the ground-side charger, then the process proceeds to 410 where the control unit is configured into a stationary charge mode of operation. Then, at 415, FIG. 4A, a decision is made as to whether the SCU controller receives a user request signal or trigger signal indicating a user request to provide fuel cell power flow back into the power grid, i.e., back to the ground-side charger. Such a trigger signal is generated at the vehicle (or charger) that would provide an indication to the SCU whether the charge is in-bound (i.e., charging the vehicle from the grid) or outbound (i.e., charging the grid from the vehicle). If it is determined at 415 that no user request signal or trigger signal has been received indicating a user request to provide fuel cell power flow back into the power grid, the process proceeds at 423 to configure the system to charge the vehicle batteries from the grid, i.e., provide power charge from the system back to the vehicle. Otherwise, if it is determined at 415 that a trigger signal has been received indicating an export mode of operation responsive to the user request to provide fuel cell power flow back into the power grid, then the process proceeds to 420. At 420, the vehicle configures the MPCS to put the vehicle into a grid charge mode, and the SCU brings up the high voltage system mode of operation 425. A high voltage system mode involves, at 430, enabling the energy storage system (ESS) and then the fuel cell system. For example, in embodiments, the ESS is normally connected to the DC bus lines 126A, 126B, however can be disconnected and electrically isolated from the DC bus to protect the ESS, e.g., when the vehicle is OFF. The SCU would also further invoke, at 435, commanding the MPCS firmware into export power operation instead of import power operation. As a result, power switches such as 111-113 and either switch 115 or 116 would receive signals to close (conduct) in order that the boosted DC voltage from the DC boost converter 35 flows to the buses 102 or 103 to either plug-in charge receptacle 52, or 53.

Continuing at 440, FIG. 4A, the SCU communicates with the ground side charger through an on-board charge controller and, through that interface, at 445, the SCU on the vehicle would get the information from the charge controller via messaging on what voltage and current (i.e., what power) to output through the MPCS for input to the charging station. This may be any amount of power up to about 125 kW. Then, at 450, based on the voltage/current information from the charging station, the SCU 1000 would command the fuel cell 25 to generate the necessary amount of power, which would flow through the MPCS and out to the charging station via the buses 102 or 103 through either plug-in charge receptacle 52, or 53. The amount of power generated from the fuel cell stack is provided as direct current at a particular level and for an associated time duration corresponding to a predetermined amount of power in response to the user request. The charge controller and vehicle controller ensure that the necessary modes were set-up and proper handshaking occurred to ensure everything is hooked up properly and that the charging station is ready to receive power from the fuel cells.

The process then proceeds to step 460, FIG. 4B which entails monitoring, in real-time, by the SCU, the amount of power flow exported through the MPCS and out to the charging station or flowed back to the grid 299, as obtained from the sensed current and voltage values monitored from respective sensors 202, 212 or 204, 214 (FIG. 3). Then, at 470, FIG. 4B, a determination is made as to whether the SCU has received a further trigger signal indicating a request to terminate the power export operations. For instance, the power export process may be terminated once the process is completed, e.g., when either terminated by the ground station or when the vehicle gets too low on hydrogen fuel and cannot produce any more power through the fuel cell, the SCU will command the system to shut down.

The length of time that the vehicle can produce power is based on demand from the fuel cell and how much hydrogen storage is on board. For example, in a system with 54 kg of useable H₂ on board, the amount of available energy in the hydrogen is 54 kg*33.33 kWh/kg=1,800 kWh. Given a fuel cell engine is about 50% efficient, it brings the amount of useable energy down to 900 kWh. The fuel cell is capable of a maximum of 125 kW output. If the storage tanks are full of hydrogen and the fuel cell is run at full power, it can create 125 kW of power for about 7 hours.

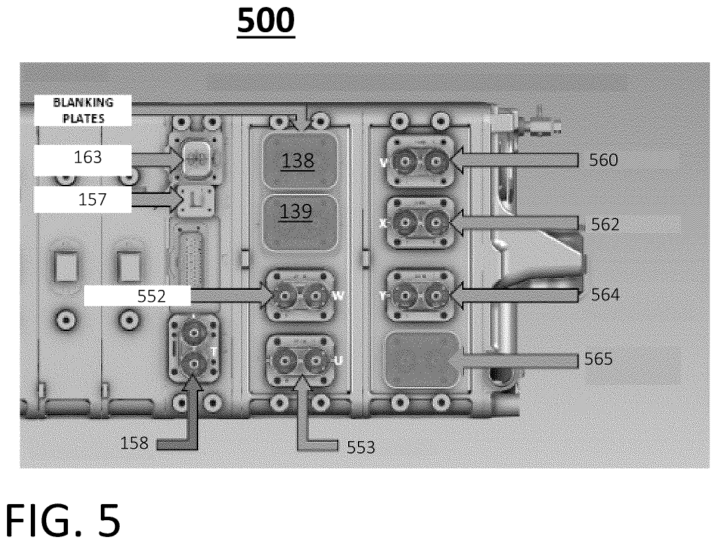

FIG. 5 shows an example housing structure 500 for the components shown in FIG. 1. Housing structure 500 includes an external connector structure 552 of the slow charge plug 52 connecting to the MPCS and an external connector structure 553 of the slow charge plug 53 connected to the MPCS. Housing 500 further includes: external connector structures 560, 562 enabling external connection with power generation fuel cell boost −'ive component and fuel cell +'ive components, respectively, for supplying power through contactors 111, 112 connecting bus wires 126 as shown in FIG. 2. A further external connector includes connector 564 enabling external connection with the vehicle fuel cell stack to provide an auxiliary high voltage supply (+'ive and −'ive). Further external connectors interfacing with the MPCS include: an external connection 157 to DC voltage bus 156 that feeds power to the vehicle cabin heater 152, an external connection 158 to DC voltage bus 155 from the high voltage ESS 180, which also feeds power to the MAPS component 190. Additionally shown in FIG. 5, is a cap structure 163 that mates to an external plug portion of the high voltage measurement port 162 shown in FIG. 2.

Further shown in the housing 500 are blanking plates 138, 139 that mate with external connector structures of MPCS charge module 175 that interface to provide power to/from the MPCS through respective switches (not shown). A further blanking plate 565 shown in FIG. 5 mates with external connector structures of MPCS filter module 110.

As used herein, the term “substantially”, or “substantial”, is equally applicable when used in a negative connotation to refer to the complete or near complete lack of an action, characteristic, property, state, structure, item, or result. For example, a surface that is “substantially” flat would either completely flat, or so nearly flat that the effect would be the same as if it were completely flat. “Substantially” when referring to a shape or size may account for manufacturing where a perfect shapes, such as circular or sizes may be difficult to manufacture.

As used herein terms such as “a”, “an” and “the” are not intended to refer to only a singular entity, but include the general class of which a specific example may be used for illustration. As used herein, terms defined in the singular are intended to include those terms defined in the plural and vice versa.

References in the specification to “one aspect”, “certain aspects”, “some aspects” or “an aspect”, indicate that the aspect(s) described may include a particular feature or characteristic, but every aspect may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other aspects whether or not explicitly described.

For purposes of the description hereinafter, the terms “upper”, “lower”, “right”, “left”, “vertical”, “horizontal”, “top”, “bottom”, and derivatives thereof shall relate to a device relative to a floor and/or as it is oriented in the figures or with respect to a surface.

As described herein, aspects of the present disclosure may include one or more electrical, pneumatic, hydraulic, or other similar secondary components and/or systems therein. The present disclosure is therefore contemplated and will be understood to include any necessary operational components thereof. For example, electrical components will be understood to include any suitable and necessary wiring, fuses, or the like for normal operation thereof. Similarly, any pneumatic systems provided may include any secondary or peripheral components such as air hoses, compressors, valves, meters, or the like. It will be further understood that any connections between various components not explicitly described herein may be made through any suitable means including mechanical fasteners, or more permanent attachment means, such as welding or the like. Alternatively, where feasible and/or desirable, various components of the present disclosure may be integrally formed as a single unit.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone may be utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments. As such, one aspect or embodiment of the present disclosure may be a computer program product including least one non-transitory computer readable storage medium in operative communication with a processor, the storage medium having instructions stored thereon that, when executed by the processor, implement a method or process described herein, wherein the instructions comprise the steps to perform the method(s) or process(es) detailed herein.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of components A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described. The terminology used herein is for the purpose of describing particular embodiments only and is not intended to be limiting the scope of the disclosure and is not intended to be exhaustive. Many modifications and variations will be apparent to those of ordinary skill in the art without departing from the scope and spirit of the disclosure.

What is claimed is:

1. A power distribution system in a hydrogen fuel cell vehicle comprising:
a hydrogen fuel cell system activated to supply direct current from hydrogen fuel cells used to power said vehicle;
a power bus for receiving said direct current from said fuel cell; and
an electrical port, the electrical port configured to receive a plug-in connection connected to a charging station external to the vehicle for receiving the directed current from the power bus, the direct current used to provide power to the charging station.

2. The power distribution system as in claim 1, further comprising:
one or more switches connected in series with the power bus, the switch activated to convey the direct current from the power bus to the plug-in connection.

3. The power distribution system as in claim 1, wherein the plug-in connection connected to the electrical port is a slow charge plug used for providing a charge to a vehicle high voltage energy storage system.

4. The power distribution system as in claim 1, further comprising:
a processor coupled to memory having instructions which, when read by the processor, cause the processor to:
receive a user request signal to export power from the vehicle; and
activate the fuel cell system to generate said direct current in response to the user request signal.

5. The power distribution system as in claim 4, wherein the direct current generated is of a level and an associated duration corresponding to a predetermined amount of power in response to the user request signal.

6. The power distribution system as in claim 5, further comprising:
a DC-to-DC converter for boosting said generated direct current to a greater level than a level produced by the fuel cell.

7. The power distribution system as in claim 6, wherein the power bus is configured to:
receive the boosted direct current directly from the DC-to-DC converter.

8. The power distribution system as in claim 5, wherein the processor device is further configured to:
transmit a handshake message via the power bus to the ground side charging station; wherein said power bus comprises a controller interfacing with the ground side charging station; and wherein the handshake message comprises data representing the configuration of the plug-in charger.

9. The power distribution system as in claim 7, wherein the instructions, when read by the processor device, further cause the processor to:
communicate messages with an on-board charge controller interfacing with the ground side charging station, including receiving messages that include a power amount, wherein, in response to receiving the power amount, the processor device further configures the hydrogen fuel cell system, and power bus to supply said direct current at a specific level for a pre-determined duration of time commensurate with the power amount.

10. The power distribution system as in claim 7, further comprising:
a current meter and a voltage meter operatively connected to said power bus to monitor and ensure an accurate supply of power to the charging station.

11. A method of operating a power distribution system comprising:
activating, under command of a processor device, a hydrogen fuel cell system to generate direct current from hydrogen fuel cells used to power said vehicle;
configuring, by the processor device, a power bus for receiving said direct current from said fuel cell; and supplying, via an electrical port, the direct current from the power bus to a charging station external to the vehicle, the direct current being supplied to provide power to the charging station.

12. The method as claimed in claim 11, wherein said power bus comprises one or more switches connected in series, the method comprising:
activating, by the processor, said one or more switches to convey the direct current from the power bus to the electrical port.

13. The method as claimed in claim 11, wherein the plug-in connection connected to the electrical port is a slow charge plug, said method further comprising: providing a charge to a vehicle high voltage energy storage system.

14. The method as claimed in claim 11, further comprising:
receiving, at the processor device, a user request signal to export power from the vehicle; and the processor responsively activating the fuel cell system to generate said direct current in response to the user request signal.

15. The method as claimed in claim 13, wherein the direct current generated is of a level and an associated duration corresponding to a predetermined amount of power in response to the user request signal.

16. The method as claimed in claim 14, further comprising:
configuring a DC-to-DC converter to boost said generated DC current power to a greater level than a level produced by the fuel cell.

17. The method as claimed in claim 15, further comprising:
configuring the power bus to receive the boosted direct current directly from the DC-to-DC converter.

18. The method as claimed in claim 15, further comprising:
configuring the processor device to transmit a handshake message via the power bus to the ground side charging station; wherein said power bus comprises a controller interfacing with the ground side charging station; and wherein the handshake message comprises data representing the configuration of the plug-in charger.

19. The method as claimed in claim 17, further comprising:
configuring the processor device to communicate messages with an on-board charge controller interfacing with the ground side charging station; and
receiving, by the processor, from the charge controller, a message including a power amount, wherein, in response to receiving the power amount, the processor device further configures the hydrogen fuel cell system, and power bus to supply said direct current at a specific level for a pre-determined duration of time commensurate with the power amount.

20. The method as claimed in claim 18, further comprising:
monitoring said power bus, using a current meter and a voltage meter operatively connected to said power bus, to ensure an accurate supply of power to the charging station.
